(19) United States
(12) Patent Application Publication
(10) Pub. No.: US 2024/0399316 A1
(43) Pub. Date: Dec. 5, 2024

(54) CERAMIC BASE MATERIAL, CERAMIC SUPPORT, AND SEPARATION MEMBRANE COMPLEX

(71) Applicant: NGK INSULATORS, LTD., Nagoya-City (JP)

(72) Inventors: Takahiro NAKANISHI, Nagoya-City (JP); Kenichi NODA, Nagoya-City (JP); Naoto KINOSHITA, Nagoya-City (JP); Nao AMANO, Ichinomiya-City (JP); Azumi HIRANE, Nagoya-City (JP)

(21) Appl. No.: 18/801,894

(22) Filed: Aug. 13, 2024

Related U.S. Application Data
(63) Continuation of application No. PCT/JP2023/005691, filed on Feb. 17, 2023.

(30) Foreign Application Priority Data
Feb. 28, 2022 (JP) 2022-029265

(51) Int. Cl. B01D 69/10; B01D 71/02; C04B 35/117; C04B 38/00

(52) U.S. Cl. CPC B01D 69/108; B01D 71/0281; C04B 35/117; C04B 38/0006; C04B 2235/3217; C04B 2235/36; C04B 2235/5436

(57) ABSTRACT

A base material utilized for supporting a separation membrane includes a plurality of coarse particles each being a ceramic particle having a particle diameter of greater than or equal to 30 μm and a plurality of fine particles each being a ceramic particle having a particle diameter of greater than or equal to 1 μm and less than 30 μm. The ratio of the number of coarse particles to the number of fine particles (i.e., coarse particle ratio) is higher than or equal to 0.05 and lower than or equal to 0.3. The coarse particles have an average aspect ratio of higher than or equal to 1.5 and lower than or equal to 2.

### CROSS-REFERENCE TO RELATED APPLICATIONS

The present application is a continuation application of International Application No. PCT/JP2023/005691 filed on Feb. 17, 2023, which claims the benefit of priority to Japanese Patent Application No. 2022-029265 filed on Feb. 28, 2022. The entire contents of these applications are incorporated herein by reference.

### TECHNICAL FIELD

The present invention relates to a ceramic base material, a ceramic support including the ceramic base material, and a separation membrane complex including the ceramic base material.

### BACKGROUND ART

Various studies and developments are currently underway on separation, adsorption, or the like of specific molecules via a separation membrane such as a zeolite membrane. For example, the separation membrane may be formed on a porous support and used as a separation membrane complex. In general, the resistance to permeability of the porous support and the strength of the porous support are controlled by porosity or pore diameter distribution. For example, increasing the porosity reduces the resistance to permeability, but lowers the strength of the porous support. On the other hand, reducing the porosity improves the strength of the porous support, but increases the resistance to permeability.

In view of this, Japanese Patent Application Laid-Open No. S62-252381 (Document 1) proposes a porous zirconia material that includes 100 parts by weight of coarse crystal particles and 20 parts by weight or more of fine crystal particles. In the porous zirconia material, the fine crystal particles are present among the coarse crystal particles and bind the coarse crystal particles together. This increases the porosity and permeability of the porous zirconia material and thereby reduces the resistance to permeability while increasing the strength of the porous zirconia material. Japanese Patent Application Laid-Open No. 2011-201722 (Document 2) and Japanese Patent Application Laid-Open No. 2008-156170 (Document 3) also propose porous materials that include coarse particles and fine particles.

In order for the aforementioned porous materials to achieve both a reduction in resistance to permeability and the securing of strength, at least it is necessary to control particle diameter of the porous materials after firing. However, Document 2 merely describes controlling the particle diameter of a raw material, such as setting the volume ratio of fine zeolite particles and coarse zeolite particles in a zeolite raw material. In the firing of the zeolite raw material, the particle diameters of fired zeolite crystals variously change depending on the firing temperature or other conditions. Thus, achieving both a reduction in resistance to permeability and the securing of strength is not easy by simply controlling the particle diameter of the raw material.

Even in the case where the weight ratio of the coarse crystal particles and the fine crystal particles in the porous zirconia material is set as in Document 1, it is not enough and it is difficult to favorably reduce the resistance to permeability of the porous zirconia material while securing the strength of the porous zirconia material.

### SUMMARY OF THE INVENTION

The present invention is intended for a porous ceramic base material utilized for supporting a separation membrane, and it is an object of the present invention to achieve both a reduction in resistance to permeability of the ceramic base material and the securing of strength of the ceramic base material.

A ceramic base material according to one preferable embodiment of the present invention includes a plurality of coarse particles each being a ceramic particle having a particle diameter of greater than or equal to 30 μm, and a plurality of fine particles each being a ceramic particle having a particle diameter of greater than or equal to 1 μm and less than 30 μm. A ratio of a total number of the plurality of coarse particles to a total number of the plurality of fine particles is higher than or equal to 0.05 and lower than or equal to 0.3. The plurality of coarse particles have an average aspect ratio of higher than or equal to 1.5 and lower than or equal to 2.

According to the present invention, it is possible to achieve both a reduction in resistance to permeability and the securing of strength.

Preferably, the ceramic base material further includes an inorganic binding material that binds the plurality of coarse particles and/or the plurality of fine particles. The number of fine particles whose entire circumferences are surrounded by the inorganic binding material among the plurality of fine particles is greater than 5% and less than 55% of the total number of the plurality of fine particles.

Preferably, the ceramic base material having a porosity of higher than or equal to 20% and lower than or equal to 50%.

Preferably, the plurality of coarse particles and the plurality of fine particles are particles of alumina, mullite, zirconia, or titania.

Preferably, the ceramic base material has a column-like shape extending in a longitudinal direction. The ceramic base material includes a plurality of cells that penetrate the ceramic base material in the longitudinal direction.

The present invention is also intended for a porous ceramic support utilized for supporting a separation membrane. A ceramic support according to one preferable embodiment of the present invention includes the ceramic base material described and a porous ceramic additional layer provided on a surface of the ceramic base material and having a mean pore diameter smaller than a mean pore diameter of the ceramic base material.

The present invention is also intended for a separation membrane complex. A separation membrane complex according to one preferable embodiment of the present invention includes 7. either the ceramic base material described above or the ceramic support described above, and a separation membrane provided on a surface of the ceramic base material or on the ceramic additional layer of the ceramic support.

Preferably, the separation membrane is a zeolite membrane.

Preferably, a zeolite constituting the zeolite membrane is composed of an 8- or less-membered ring at maximum.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a sectional view of a separation membrane complex according to one embodiment.

FIG. 2 is a sectional view showing part of the separation membrane complex in enlarged dimensions.

FIG. 3 is a diagram showing part of a polished section image of a base material in enlarged dimensions.

FIG. 4 is a diagram showing part of a polished section image of the base material in enlarged dimensions.

FIG. 5 is flowchart showing the production of the separation membrane complex.

FIG. 6 is a sectional view of a separation apparatus.

FIG. 7 is a flowchart showing the separation of a mixture of substances.

### DETAILED DESCRIPTION

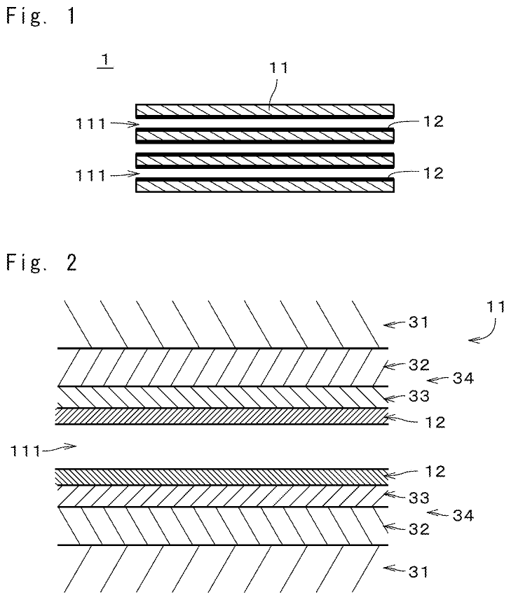

FIG. 1 is a sectional view of a separation membrane complex 1 according to one embodiment of the present invention. FIG. 2 is a sectional view showing part of the separation membrane complex 1 in enlarged dimensions. The separation membrane complex 1 includes a ceramic support 11 (hereinafter, also simply referred to as the “support 11”) and a separation membrane 12. In the illustration of FIG. 1, the separation membrane 12 is shown in thick lines. In the illustration of FIG. 2, the support 11 and the separation membrane 12 are cross-hatched, and the thickness of the separation membrane 12 is greater than the actual thickness.

The support 11 is a porous member that is permeable to gas and liquid. In the example shown in FIG. 1, the support 11 is a monolith support that includes a plurality of through holes 111 (hereinafter, also referred to as “cells 111”) each extending in a longitudinal direction of an integrally-molded column-like body (i.e., the right-left direction in FIG. 1). For example, the support 11 may have an approximately column-like outside shape. The cells 111 may be arranged in, for example, a matrix in a section of the support 11 perpendicular to the longitudinal direction. For example, each cell 111 may have an approximately circular section perpendicular to the longitudinal direction. Note that “approximately circular” includes not only a perfect circle but also an ellipse or a distorted circle. It is preferable that each cell 111 may have a perfect circular sectional shape, but the sectional shape does not necessarily need to be a perfect circle. In the illustration of FIG. 1, the diameter of the cells 111 is greater than the actual diameter, and the number of cells 111 is smaller than the actual number.

The separation membrane 12 is arranged on the inner surface of each cell 111. Preferably, the separation membrane 12 may be provided to cover approximately the entire inner surface of each cell 111. The support 11 is utilized for supporting the separation membrane 12.

The support 11 may have a length (i.e., a length in the right-left direction in FIG. 1) of, for example, 10 cm to 200 cm. The outside diameter of the support 11 may be in the range of, for example, 0.5 cm to 30 cm. A distance between the central axes of each pair of adjacent cells 111 may be in the range of, for example, 0.3 mm to 10 mm. Surface roughness (Ra) of the support 11 may be in the range of, for example, 0.1 μm to 5.0 μm and preferably in the range of 0.2 μm to 2.0 μm. Note that the shape of the support 11 may be any other shape such as a honeycomb shape, a flat plate-like shape, a tube-like shape, a cylinder-like shape, a column-like shape, or a polygonal column-like shape. In the case where the support 11 has a tube- or cylinder-like shape, the support 11 may have a thickness of, for example, 0.1 mm to 10 mm.

The support 11 may have, for example, a multilayer structure in which a plurality of layers having different mean pore diameters are laminated one above another in the thickness direction in the vicinity of the inner surfaces of the cells 111 (i.e., in the vicinity of the separation membrane 12). In the example shown in FIG. 2, the support 11 includes a porous ceramic base material 31 (hereinafter, also simply referred to as the “base material 31”) and a porous ceramic additional layer 34 (hereinafter, also simply referred to as the “additional layer 34”) provided on the surface of the base material 31.

The additional layer 34 includes a porous intermediate layer 32 formed directly on the base material 31 and a porous surface layer 33 formed on the intermediate layer 32. That is, the surface layer 33 is provided indirectly on the base material 31 via the intermediate layer 32. The intermediate layer 32 is provided between the base material 31 and the surface layer 33. The surface layer 33 configures the inner surface of each cell 111 of the support 11, and the separation membrane 12 is formed on the surface layer 33. The surface layer 33 may have a thickness of, for example, 1 μm to 100 μm. The intermediate layer 32 may have a thickness of, for example, 100 μm to 500 μm. Note that the intermediate layer 32 and the surface layer 33 may or may not be provided on the outer surface and longitudinal end faces of the support 11.

The material for the support 11 (i.e., the base material 31, the intermediate layer 32, and the surface layer 33) is ceramic having chemical stability in the process of forming the separation membrane 12 on the surface of the support 11. In the present embodiment, the support 11 is formed of a ceramic sintered body. Examples of the ceramic sintered body selected as the material for the support 11 include alumina, silica, mullite, zirconia, titania, yttria, silicon nitride, and silicon carbide. Preferably, the support 11 may be formed of alumina, mullite, zirconia, or titania. The base material 31, the intermediate layer 32, and the surface layer 33 may be formed of the same material, or may be formed of different materials.

The support 11 (i.e., the base material 31, the intermediate layer 32, and the surface layer 33) may include, for example, an inorganic binding material for binding aggregate particles of the aforementioned ceramic sintered body. As the inorganic binding material, at least one of titania, mullite, easily sinterable alumina, silica, glass frit, clay minerals, and easily sinterable cordierite may be used.

The support 11 may further contain alkali metal and/or alkali earth metal. Examples of the alkali metal and the alkali earth metal include sodium (Na), potassium (K), calcium (Ca), and magnesium (Mg).

The mean pore diameter of the surface layer 33 is smaller than the mean pore diameters of the intermediate layer 32 and the base material 31. The mean pore diameter of the intermediate layer 32 is smaller than the mean pore diameter of the base material 31. That is, the mean pore diameter of the additional layer 34 is smaller than the mean pore diameter of the base material 31. The base material 31 may have a mean pore diameter of, for example, greater than or equal to 1 μm and less than or equal to 70 μm. The intermediate layer 32 may have a mean pore diameter of, for example, greater than or equal to 0.1 μm and less than or equal to 10 μm. The surface layer 33 may have a mean pore diameter of, for example, greater than or equal to 0.005 μm and less than or equal to 2 μm. The mean pore diameters of the base material 31, the intermediate layer 32, and the surface layer 33 can be measured by, for example, a mercury porosimeter, a perm porometer, or a nano-perm porometer.

For example, the surface layer 33, the intermediate layer 32, and the base material 31 may have approximately the same porosity. Note that the surface layer 33, the intermediate layer 32, and the base material 31 may have different porosities. The porosities of the surface layer 33, the intermediate layer 32, and the base material 31 may, for example, be higher than or equal to 20% and lower than or equal to 50%.

The porosity of the base material 31 can be obtained by the following procedure. Firstly, the pores of the base material 31 are filled with a resin and subjected to mechanical polishing to prepare a polished section. Then, the polished section is observed with a laser microscope to obtain an image (hereinafter, also referred to as a “polished section image”). Then, the polished section image is binarized and color-coded into pore portions, particle portions, and inorganic-binding-material portions, and the ratio of the pore portions in the entire polished section image is defined as the porosity. The porosities of the intermediate layer 32 and the surface layer 33 can also be obtained in accordance with an approximately similar procedure.

An average particle diameter of the aggregate particles of the surface layer 33 (i.e., a median diameter (D₅₀) in the volume-based particle diameter distribution) is smaller than an average particle diameter of the aggregate particles of the intermediate layer 32. The average particle diameter of the aggregate particles of the intermediate layer 32 is smaller than an average particle diameter of the aggregate particles of the base material 31. The average particle diameters of the aggregate particles of the base material 31, the intermediate layer 32, and the surface layer 33 can be measured by, for example, a laser diffraction method.

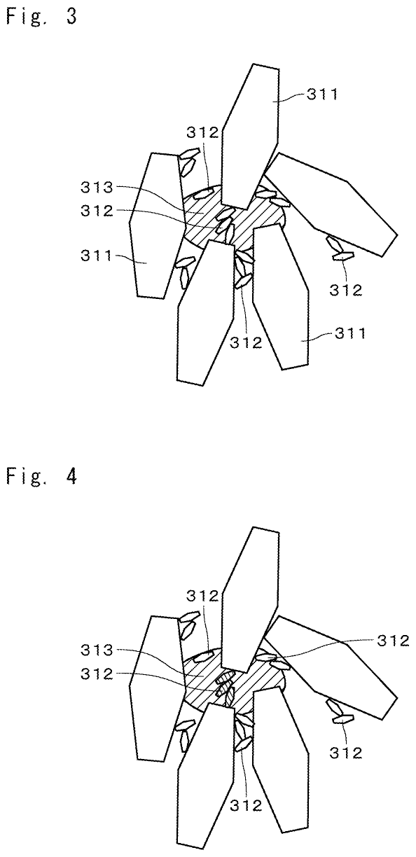

FIG. 3 is a diagram showing part of the polished section image of the base material 31 in enlarged dimensions. The base material 31 includes a plurality of coarse particles 311 (i.e., coarse crystal particles) and a plurality of fine particles 312 (i.e., minute crystal particles) as the aggregate particles. The coarse particles 311 are ceramic particles each having a particle diameter of greater than or equal to 30 μm. The coarse particles 311 have an average aspect ratio of higher than or equal to 1.5 and lower than or equal to 2. The fine particles 312 are ceramic particles each having a particle diameter of greater than or equal to 1 μm and less than 30 μm. In the base material 31, the ratio of the number of coarse particles 311 (hereinafter, also referred to as the “coarse particle ratio”) to the number of fine particles 312 is higher than or equal to 0.05 and lower than or equal to 0.3. As described above, the coarse particles 311 and the fine particles 312 may preferably be particles of alumina, mullite, zirconia, or titania. In the present embodiment, the coarse particles 311 and the fine particles 312 are alumina particles.

The particle diameter of the aggregate particles (i.e., the coarse particles 311 and the fine particles 312) of the base material 31 can be obtained in accordance with the following procedure. Firstly, the pores of the base material 31 are filled with a resin and subjected to machine polishing to prepare a polished section. Then, attention is given to one aggregate particle in an image obtained by observing the polished section with a laser microscope (i.e., the polished section image), and two parallel straight lines are caused to circumscribe the one aggregate particle. Then, the orientation of the two straight lines is changed while maintaining a state in which the two straight lines circumscribe the aggregate particle. When the two straight lines are oriented so as to have a maximum interval therebetween, this interval is acquired as the major axis of the aggregate particle. Assuming this major axis as the particle diameter of the aggregate particle, aggregate particles whose major axes are greater than or equal to 30 μm are referred to as the coarse particles 311, and aggregate particles whose major axes are greater than or equal to 1 μm and less than 30 μm are referred to as the fine particles 312. Note that particles whose major axes are less than 1 μm are included in neither the coarse particles 311 nor the fine particles 312.

The average aspect ratio of the coarse particles 311 of the base material 31 can be obtained in accordance with the following procedure. Firstly, for each of 30 coarse particles 311 in the aforementioned polished section image, the length in the direction perpendicular to the major axis (i.e., minor axis) is obtained, and a value obtained by dividing the major axis by the minor axis is acquired as the aspect ratio of the coarse particle 311. Then, an arithmetical mean of the aspect ratios of the 30 coarse particles 311 is obtained as the average aspect ratio of the coarse particles 311.

The coarse particle ratio can be obtained in accordance with the following procedure. Firstly, the aforementioned polished section image is obtained at 1000× magnification. Then, the number of coarse particles 311 and the number of fine particles 312 in the polished section image are counted by viewing. At this time, if the number of coarse particles 311 included in the polished section image is less than 50, the position on the base material 31 is changed to again acquire another polished section image, and the number of coarse particles 311 and the number of fine particles 312 are counted by viewing. Then, the acquired number of coarse particles 311 is divided by the acquired number of fine particles 312 so as to obtain the coarse particle ratio.

The inclusion of the coarse particles 311 as the aggregate particles in the base material 31 increases interstices between the aggregate particles and accordingly reduces the resistance to permeability of the base material 31. However, on the other hand, the inclusion of the coarse particles 311 degrades sintering of the aggregate particles and weakens the necking (binding) between the aggregate particles. This results in a reduction in mechanical strength (hereinafter, also simply referred to as “strength”) of the base material 31. Moreover, the inclusion of the fine particle 312 as the aggregate particles in the base material 31 improves the sintering of the aggregate particles and enhances the necking between the aggregate particles. This results in an increase in the strength of the base material 31. However, on the other hand, the inclusion of the fine particles 312 reduces interstices between the aggregate particles and accordingly increases the resistance to permeability of the base material 31. The base material 31 is capable of achieving both a reduction in resistance to permeability and the securing of strength by setting the coarse particle ratio to be higher than or equal to 0.05 and lower than or equal to 0.3 as described above.

In the base material 31, the coarse particles 311 have an average aspect ratio of higher than or equal to 1.5, so that the interstices between adjacent coarse particles 311 become relatively linear (e.g., the interstices have a lower degree of curvature) as compared with the case where the coarse particles 311 have an average aspect ratio of lower than 1.5. Therefore, it is possible to reduce the resistance to permeability of the base material 31. Besides, the coarse particles 311 have an average aspect ratio of lower than or equal to 2 to ensure relatively large contact between adjacent coarse particles 311. Therefore, it is possible to inhibit weakening of the necking between the aggregate particles. Accordingly, the base material 31 is capable of achieving both a reduction in resistance to permeability and the securing of strength.

The base material 31 includes an inorganic binding material 313 that binds the coarse particles 311 and/or the fine particles 312. To facilitate understanding of the drawing, the inorganic binding material 313 is cross-hatched in FIG. 3. In the polished section image, the inorganic binding material 313 may, for example, be translucent. The inorganic binding material 313 may bind the coarse particles 311 together, bind the coarse particle 311 and the fine particle 312 together, or bind the fine particles 312 together. For example, the inorganic binding material 313 may be glass frit or titania. In the base material 311, the necking between the aggregate particles is reinforced by the inorganic binding material 313. This improves the strength of the base material 31.

In the base material 31, it is also preferable that the fine particles 312 may be surrounded by the inorganic binding material 313. This reduces grain boundaries around the fine particles 312 and reduces the occurrence of cracks resulting from grain boundaries. From the viewpoint of improving the strength of the base material 311 as a result of reduced occurrence of cracks, it is preferable that the number of fine particles 312 whose entire circumferences are surrounded by the inorganic binding material 313 among all of the fine particles 312 may be greater than or equal to 5% of the total number of fine particles 312. On the other hand, if the inorganic binding material 313 increases in amount, the interstices between the aggregate particles are filled with the inorganic binding material 311 and this increases the resistance to permeability of the base material 31. From the viewpoint of reducing the resistance to permeability of the base material 31, it is preferable that the number of fine particles 312 whose entire circumferences are surrounded by the inorganic binding material 313 among all of the fine particles 312 may be less than or equal to 55% of the total number of fine particles 312. In the following description, the ratio of the number of fine particles 312 whose entire circumferences are surrounded by the inorganic binding material 313 to the total number of fine particles 312 is also referred to as the “surrounded fine particle ratio.”

Similarly to FIG. 3, FIG. 4 is a diagram showing part of the polished section image of the base material 31 in enlarged dimensions. In the illustration of FIG. 4, fine particles 312 whose entire circumferences are surrounded by the inorganic binding material 313 among all of the fine particles 312 are cross-hatched. As shown in FIG. 4, the fine particles 312 whose entire circumferences are surrounded by the inorganic binding material 313 mean fine particles 312 that are entirely located in positions spaced from the outer edge of the inorganic binding material 313 on the inner side of the outer edge of the inorganic binding material 313. In the case where at least part of a fine particle 312 is located outside the outer edge of the inorganic binding material 313, this fine particle 312 is determined as not being entirely surrounded by the inorganic binding material 313. Even in the case where the whole of a fine particle 312 is located on the inner side of the outer edge of the inorganic binding material 313, if the outer edge of the fine particle 312 is in contact with the outer edge of the inorganic binding material 313, this fine particle 312 is also determined as not being entirely surrounded by the inorganic binding material 313.

The separation membrane 12 shown in FIG. 2 is formed on the inner surface of each cell 111 (i.e., on the surface layer 33 of the additional layer 34) and covers approximately the entire inner surface as described above. The separation membrane 12 is a porous membrane having minute pores. The separation membrane 12 separates a specific substance from a mixture of substances including a plurality of types of substances. In the present embodiment, the separation membrane 12 may have an approximately cylinder-like shape.

The separation membrane 12 may preferably be an inorganic membrane formed of an inorganic material and more preferably be a zeolite membrane. That is, the separation membrane complex 1 may preferably be an inorganic membrane complex and more preferably be a zeolite membrane complex. The zeolite membrane refers to at least a zeolite formed into a membrane on the surface of the support 11 and does not include a membrane formed by simply dispersing zeolite particles in an organic membrane. In the present embodiment, the separation membrane 12 is a zeolite membrane. The separation membrane 12 may be a zeolite membrane that contains two or more types of zeolites having different structures or compositions.

The separation membrane 12 may have a thickness of, for example, greater than or equal to 0.05 μm and less than or equal to 50 μm, preferably greater than or equal to 0.1 μm and less than or equal to 20 μm, and more preferably greater than or equal to 0.5 μm and less than or equal to 10 μm. Increasing the thickness of the separation membrane 12 improves separation performance. Reducing the thickness of the separation membrane 12 increases permeance. Surface roughness (Ra) of the separation membrane 12 may, for example, be less than or equal to 5 μm, preferably less than or equal to 2 μm, more preferably less than or equal to 1 μm, and yet more preferably less than or equal to 0.5 μm. The separation membrane 12 may have a pore diameter of, for example, 0.2 nm to 1 nm. The pore diameter of the separation membrane 12 is smaller than the mean pore diameter of the surface layer 33 of the support 11.

In the case where the zeolite constituting the separation membrane 12 is composed of an n-membered ring at the maximum, the minor axis of the n-numbered ring pore is assumed to be the pore diameter of the separation membrane 12. In the case where the zeolite includes a plurality of types of n-membered ring pores where n is the same number, the minor axis of an n-membered ring pore having a largest minor axis is assumed to be the pore diameter of the separation membrane 12. Note that the n-membered ring refers to a ring in which n oxygen atoms compose the framework of each pore and each oxygen atom is bonded to T atoms described later to form a cyclic structure. The n-membered ring also refers to a ring that forms a through hole (channel), and does not include a ring that does not form a through hole. The n-membered ring pore refers to a pore formed of an n-membered ring. From the viewpoint of improving selectivity, it is preferable that the zeolite constituting the aforementioned separation membrane 12 may be composed of an 8- or less-membered ring (e.g., 6- or 8-membered ring) at the maximum.

The pore diameter of the separation membrane 12 is uniquely determined by the framework structure of the zeolite and obtained from values disclosed in “Database of Zeolite Structures” [online], by International Zeolite Association, Internet <URL: http://www.iza-structure.org/databases/>.

There are no particular limitations on the type of the zeolite constituting the separation membrane 12, and the zeolite may, for example, be an AEI-, AEN-, AFN-, AFV-, AFX-, BEA-, CHA-, DDR-, ERI-, ETL-, FAU-(X-type, Y-type), GIS-, IHW-, LEV-, LTA-, LTJ-, MEL-, MFI-, MOR-, PAU-, RHO-, SOD-, or SAT-type zeolites. In the case where the zeolite is an 8-membered ring zeolite, the zeolite may, for example, be an AEI-, AFN-, AFV-, AFX-, CHA-, DDR-, ERI-, ETL-, GIS-, IHW-, LEV-, LTA-, LTJ-, RHO-, or SAT-type zeolites. In the present embodiment, the zeolite constituting the separation membrane 12 is a DDR-type zeolite.

The zeolite constituting the separation membrane 12 may contain, for example, at least one of silicon (Si), aluminum (Al), and phosphorus (P) as T atoms (i.e., atoms located in the center of oxygen tetrahedron (TO₄) that constituting the zeolite). The zeolite of the separation membrane 12 may, for example, be a zeolite in which T atoms are composed of only Si or of Si and Al, an AlPO-type zeolite in which T atoms are composed of Al and P, an SAPO-type zeolite in which T atoms are composed of Si, Al, and P, an MAPSO-type zeolite in which T atoms are composed of magnesium (Mg), Si, Al, and P, or a ZnAPSO-type zeolite in which T atoms are composed of zinc (Zn), Si, Al, and P. Some of the T atoms may be replaced by other elements. The zeolite constituting the separation membrane 12 may contain alkali metal. The alkali metal may, for example, be sodium (Na) or potassium (K).

In the case where the zeolite constituting the separation membrane 12 contains Si atoms and Al atoms, the Si/Al ratio in the zeolite of the separation membrane 12 may, for example, be higher than or equal to one and lower than or equal to a hundred thousand. The Si/Al ratio refers to the molar ratio of Si elements to Al elements contained in the zeolite of the separation membrane 12. The Si/Al ratio may preferably be higher than or equal to 5, more preferably higher than or equal to 20, and yet more preferably higher than or equal to 100. It is preferable that the Si/Al ratio is as high as possible because the separation membrane 12 can achieve higher resistance to heat and acids. The Si/Al ratio can be adjusted by adjusting, for example, the compounding ratio of an Si source and an Al source in a starting material solution, which will be described later.

The separation membrane complex 1 may omit either the intermediate layer 32 or the surface layer 33 of the additional layer 34. As another alternative, the additional layer 34 may have a laminated structure including three or more layers. As yet another alternative, in the separation membrane complex 1, the additional layer 34 may be omitted and the base material 31 alone may function as the support 11. In this case, the separation membrane 12 is provided directly on the surface of the base material 31.

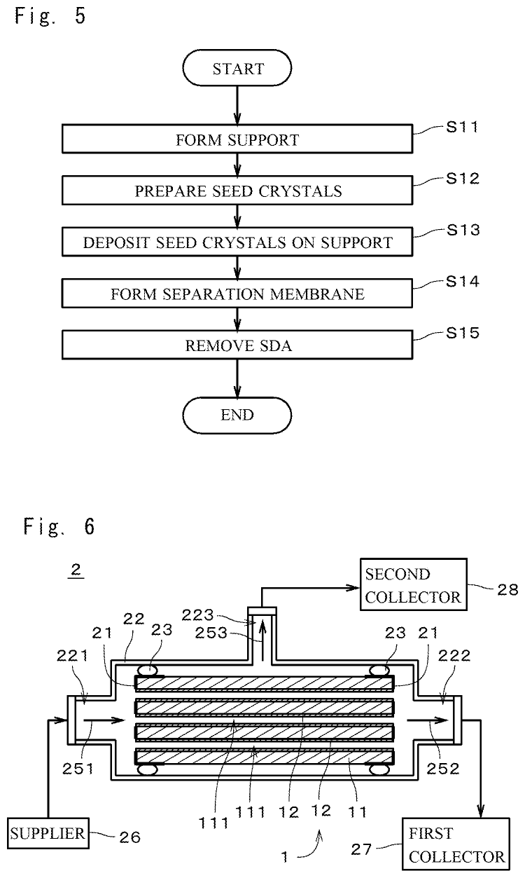

Next, one example of the procedure for the production of the separation membrane complex 1 will be described with reference to FIG. 5. In the production of the separation membrane complex 1, firstly, the support 11 is formed (step S11). Specifically, a green body serving as a starting material for the base material 31 of the support 11 is prepared by kneading, for example, ceramic particles, an inorganic binding material, water, a dispersant, and a thickener together. Then, the green body is molded into a monolith molded body by, for example, extrusion molding. The molded body is then fired to obtain the base material 31.

In the aforementioned preparation of the green body, for example, 3 to 25 parts by mass of the inorganic binding material is added to the ceramic particles (in the present embodiment, alumina particles) serving as the aggregate particles. The ceramic particles include coarse starting-material particles having large particle diameters and fine starting-material particles having small particle diameters. The content of the coarse starting-material particles in the ceramic particles (i.e., the value shown in percentage and obtained by dividing the mass of the coarse starting-material particles by the total mass of the coarse starting-material particles and the fine starting-material particles) may be in the range of, for example, 5 mass % to 30 mass %. In the volume-based particle diameter distribution of the coarse starting-material particles, D₁₀ is in the range of 60 μm to 100 μm, D₅₀ (i.e., the average particle diameter) is in the range of 80 μm to 200 μm, and D₉₀ is in the range of 200 μm to 300 μm. In the volume-based particle diameter distribution of the fine starting-material particles, D₁₀ is in the range of 3 μm to 10 μm, D₅₀ (i.e., the average particle diameter) is in the range of 20 μm to 60 μm, and D₉₀ is in the range of 60 μm to 160 μm. The firing temperature for the aforementioned molded body may be in the range of, for example, 500° C. to 1500° C. and is 1250° C. in the present embodiment. The firing time for the aforementioned molded body may be in the range of one hour to 100 hours and is two hours in the present embodiment.

After the formation of the base material 31 has ended, the intermediate layer 32 is formed on the inner surfaces of a plurality of through holes of the base material 31 (i.e., through holes that are to be the cells 111), and the surface layer 33 is formed on the intermediate layer 32 so as to form the support 11. The formation of the intermediate layer 32 and the surface layer 33 may be performed by, for example, a filtration deposition method. In the formation of the intermediate layer 32, firstly, the aggregate particles of the intermediate layer 32, an organic binding material, a pH adjustor, a surface-active agent, and so on are added to and mixed with water, and the resultant is diluted with a predetermined amount of water so as to prepare slurry. Then, the slurry is admitted into the aforementioned through holes of the base material 31 to form a membrane of the aggregate particles of the intermediate layer 32 on the inner surfaces of the through holes. Thereafter, this membrane is fired together with the base material 31 to form the intermediate layer 32. The formation of the surface layer 33 is approximately the same as the formation of the intermediate layer 32.

After the formation of the support 11, seed crystals utilized for forming the separation membrane 12 are synthesized and prepared (step S12). In the synthesis of the seed crystals, a starting material such as an Si source, a structure-directing agent (hereinafter also referred to as an “SDA”), and so on are dissolved or dispersed in a solvent to prepare a starting material solution of the seed crystals. Then, the starting material solution is subjected to hydrothermal synthesis, and resultant crystals are washed and dried so as to obtain zeolite powder. The zeolite powder may be used as-is as the seed crystals, or may be processed into the seed crystals by pulverization or any other method. Note that the synthesis of the seed crystals in step S12 may be performed in parallel with or before the aforementioned formation of the support 11 in step S11.

Next, a dispersion obtained by dispersing the seed crystals in a solvent (e.g., water or alcohol such as ethanol) is admitted into the cells 111 of the support 11. For example, the support 11 may be placed on a base such that the longitudinal direction of the support 11 becomes approximately parallel to the direction of gravity, and the dispersion is admitted into each cell 111 from the upper opening of the cell 111 so that the seed crystals in the dispersion are deposited on the inner surfaces of the cells 111 (step S13). Specifically, the seed crystals are deposited on the surface of the additional layer 34. The dispersion admitted into the cells 111 are discharged from the lower openings of the cells 111.

Preferably, step S13 may be repeated multiple times (e.g., twice to ten times). More preferably, the support 11 may be turned upside down during the repetitions in step S13. This prepares a seed-crystal-deposited support in which the seed crystals are deposited uniformly on the inner surfaces of the cells 111. Note that the seed crystals may be deposited by any other method on the inner surfaces of the cells 111.

Then, the support 11 with the seed crystals deposited thereon is immersed in a starting material solution. The starting material solution may be prepared by, for example, dissolving an Si source, an SDA, and so on in a solvent. The solvent in the starting material solution may, for example, be water or alcohol such as ethanol. The SDA contained in the starting material solution may, for example, be an organic compound. As the SDA, 1-adamantanamine may be used, for example.

Then, the zeolite is grown by hydrothermal synthesis using the seed crystals as nuclei so as to form the separation membrane 12 on the inner surface of each cell 111 of the support 11 (i.e., on the additional layer 34) (step S14). The hydrothermal synthesis temperature may preferably be in the range of 120° C. to 200° C. and may be 160° C., for example. The hydrothermal synthesis time may preferably be in the range of five hours to 100 hours and may be 30 hours, for example.

After the hydrothermal synthesis has ended, the support 11 and the separation membrane 12 are washed with deionized water. The support 11 and the separation membrane 12 after washing are dried at, for example, 80° C. After the drying of the support 11 and the separation membrane 12, the separation membrane 12 is subjected to heat treatment (i.e., firing) so as to almost completely burn and remove the SDA in the separation membrane 12 and to allow the micropores in the separation membrane 12 to penetrate the separation membrane 12. In this way, the aforementioned separation membrane complex 1 is obtained (step S15).

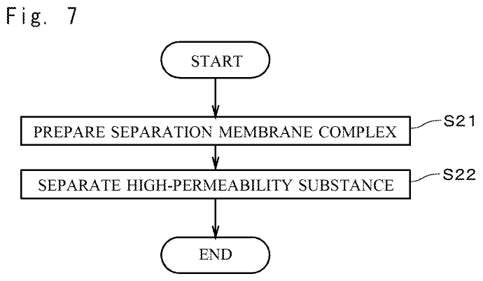

Next, the separation of a mixture of substances using the separation membrane complex 1 will be described with reference to FIGS. 6 and 7. FIG. 6 is a sectional view of a separation apparatus 2. To facilitate understanding of the drawing, a section of the separation membrane complex 1 is conceptually shown in simplified form in FIG. 6. FIG. 7 is a flowchart showing the separation of a mixture of substances by the separation apparatus 2.

The separation apparatus 2 supplies a mixture of substances including a plurality of types of fluid (i.e., gas or liquid) to the separation membrane complex 1 and causes a substance having high permeability in the mixture of substances to permeate the separation membrane complex 1 in order to separate the substance having high permeability from the mixture of substances. The separation by the separation apparatus 2 may be performed for the purpose of extracting a substance having high permeability (hereinafter, also referred to as a “high-permeability substance”) from the mixture of substances or for the purpose of condensing a substance having low permeability (hereinafter, also referred to as a “low-permeability substance”).

The mixture of substances (i.e., a fluid mixture) may be a mixed gas that includes a plurality of types of gas, a mixed solution that includes a plurality of types of liquid, or a gas-liquid two-phase fluid that includes both gas and liquid.

For example, the mixture of substances may contain one or more types of substances among hydrogen (H₂), helium (He), nitrogen (N₂), oxygen (O₂), water (H₂O), carbon monoxide (CO), carbon dioxide (CO₂), nitrogen oxides, ammonia (NH₃), sulfur oxides, hydrogen sulfide (H₂S), sulfur fluorides, mercury (Hg), arsine (AsH₃), hydrogen cyanide (HCN), carbonyl sulfide (COS), C1 to C8 hydrocarbons, organic acids, alcohol, mercaptans, ester, ether, ketone, and aldehyde. The aforementioned high-permeability substance may, for example, be one or more types of substances among Co₂, NH₃, and H₂O. Note that the mixture of substances and the high-permeability substance may be any substance other than those described above.

Nitrogen oxides are compounds of nitrogen and oxygen. For example, the aforementioned nitrogen oxides may be a substance called NOx such as nitrogen monoxide (NO), nitrogen dioxide (NO₂), nitrous oxide (also referred to as dinitrogen monoxide) (N₂O), dinitrogen trioxide (N₂O₃), dinitrogen tetroxide (N₂O₄), or dinitrogen pentoxide (N₂O₅).

Sulfur oxides are compounds of sulfur and oxygen. For example, the aforementioned sulfur oxides may be a substance called SOₓ such as sulfur dioxide (SO₂) or sulfur trioxide (SO₃).

Sulfur fluorides are compounds of fluorine and sulfur. For example, the aforementioned sulfur fluorides may be disulfur difluoride (F—S—S—F, S═SF₂), sulfur difluoride (SF₂), sulfur tetrafluoride (SF₄), sulfur hexafluoride (SF₆), or disulfur decafluoride (S₂F₁₀).

C1 to C8 hydrocarbons are hydrocarbons that contain one or more and eight or less carbon atoms. C3 to C8 hydrocarbons each may be any of a linear-chain compound, a side-chain compound, and a cyclic compound. C2 to C8 hydrocarbons each may be either a saturated hydrocarbon (i.e., where double bonds and triple bonds are not located in molecules) or an unsaturated hydrocarbon (i.e., where double bonds and/or triple bonds are located in molecules). C1 to C4 hydrocarbons may, for example, be methane (CH₄), ethane (C₂H₆), ethylene (C₂H₄), propane (C₃H₈), propylene (C₃H₆), normal butane (CH₃(CH₂)₂CH₃), isobutene (CH(CH₃)₃), 1-butene (CH₂=CHCH₂CH₃), 2-butene (CH₃CH═CHCH₃), or isobutene (CH₂═C(CH₃)₂).

The aforementioned organic acids may, for example, be carboxylic acids or sulfonic acids. The carboxylic acids may, for example, be formic acid (CH₂O₂), acetic acid (C₂H₄O₂), oxalic acid (C₂H₂O₄), acrylic acid (C₃H₄O₂), or benzoic acid (C₆H₅COOH). The sulfonic acids may, for example, be ethane sulfonic acid (C₂H₆O₃S). The organic acids may be either chain compounds or cyclic compounds.

The aforementioned alcohol may, for example, be methanol (CH₃OH), ethanol (C₂H₅OH), isopropanol (2-propanol) (CH₃CH(OH)CH₃), ethylene glycol (CH₂(OH)CH₂(OH)), or butanol (C₄H₉OH).

Mercaptans are organic compounds with terminal sulfur hydrides (SH) and also are substances called thiol or thioalcohol. The aforementioned mercaptans may, for example, be methyl mercaptan (CH₃SH), ethyl mercaptan (C₂H₅SH), or 1-propane thiol (C₃H₇SH).

The aforementioned ester may, for example, be formic acid ester or acetic acid ester.

The aforementioned ether may, for example, be dimethyl ether ((CH₃)₂O), methyl ethyl ether (C₂H₅OCH₃), diethyl ether ((C₂H₅)₂O), or tetrahydrofuran ((CH₂)₄O).

The aforementioned ketone may, for example, be acetone ((CH₃)₂CO), methyl ethyl ketone (C₂H₅COCH₃), or diethyl ketone ((C₂H₅)₂CO).

The aforementioned aldehyde may, for example, be acetaldehyde (CH₃CHO), propionaldehyde (C₂H₅CHO), or butanal (butyraldehyde) (C₃H-CHO).

As shown in FIG. 6, the separation apparatus 2 includes the separation membrane complex 1, a sealer 21, a housing 22, and two seal members 23. The separation membrane complex 1, the sealer 21, and the seal members 23 are placed in the housing 22. In the illustration of FIG. 6, the separation membrane 12 of the separation membrane complex 1 is cross-hatched. The internal space of the housing 22 is an enclosed space isolated from the space around the housing 22. The housing 22 is connected to a supplier 26, a first collector 27, and a second collector 28.

The sealer 21 is, as described above, a member that is attached to both end portions of the support 11 in the longitudinal direction (i.e., the left-right direction in FIG. 6) and covers and seals both longitudinal end faces of the support 11 and the outer surface of the support 11 in the vicinity of these end faces. In the present embodiment, the sealer 21 is a glass seal having a thickness of 10 μm to 50 μm. The material and shape of the sealer 21 may be changed as appropriate. Note that the sealer 21 has a plurality of openings that overlap the plurality of cells 111 of the support 11, so that both longitudinal ends of each cell 111 is not covered with the sealer 21. This allows the inflow and outflow of fluid from the longitudinal ends into and out of the cells 111.

The housing 22 is an approximately cylinder-like tubular member. For example, the housing 22 may be formed of stainless steel or carbon steel. The longitudinal direction of the housing 22 is approximately parallel to the longitudinal direction of the separation membrane complex 1. One longitudinal end of the housing 22 (i.e., the left end in FIG. 6) is provided with a supply port 221, and the other longitudinal end thereof is provided with a first exhaust port 222. The supply port 221 is connected to the supplier 26. The first exhaust port 222 is connected to the first collector 27. The side face of the housing 22 is provided with a second exhaust port 223. The second exhaust port 223 is connected to the second collector 28. Note that the shape and material for the housing 22 may be changed variously.

The two seal members 23 are arranged between the outer surface of the separation membrane complex 1 and the inner surface of the housing 22 in the vicinity of both of the longitudinal ends of the separation membrane complex 1. Each seal member 23 is an approximately ring-shaped member formed of a material that is impermeable to gas and liquid. For example, the seal members 23 may be O-rings or packings formed of a resin having flexibility. The seal members 23 are in tight contact with the outer surface of the separation membrane complex 1 and the inner surface of the housing 22 along the entire circumference of the separation membrane complex 1. In the example shown in FIG. 6, the seal members 23 are in tight contact with the outer surface of the sealer 21 and are indirectly in tight contact with the outer surface of the separation membrane complex 1 via the sealer 21. Alternatively, the sealers 23 may be directly in tight contact with the outer surface of the separation membrane complex 1. The space between each seal member 23 and either the sealer 21 or the outer surface of the separation membrane complex 1 and the space between each seal member 23 and the inner surface of the housing 22 are sealed so as to almost or completely disable the passage of gas and liquid. Note that the material for the seal members 23 may be other than a resin and may, for example, be carton, metal, or any other inorganic material.

The supplier 26 supplies a mixture of substances to the internal space of the housing 22 via the supply port 221. The supplier 26 may include, for example, a pumping mechanism such as a blower or a pump that pumps the mixture of substances toward the housing 22. The pumping mechanism may include, for example, a temperature controller and a pressure regulator that respectively adjust the temperature and pressure of the mixture of substances supplied to the housing 22. The first collector 27 and the second collector 28 may include, for example, a reservoir that stores substances derived from the housing 22, or a blower or a pump that transfers those substances.

In the separation of a mixture of substances, firstly, the separation membrane complex 1 is prepared (step S21 in FIG. 7). Specifically, the separation membrane complex 1 is attached to the inside of the housing 22. Then, the supplier 26 supplies, to the inside of the housing 22, a mixture of substances that includes a plurality of types of substances each having different permeability through the separation membrane 12 as indicated by an arrow 251. The mixture of substances may, for example, be a mixed solution obtained by mixing a plurality of types of liquid. Main components of the mixed solution may, for example, be water and ethanol. The mixed solution may further contain a liquid other than water and ethanol.

The mixture of substances supplied from the supplier 26 to the housing 22 is introduced into each cell 111 of the support 11 from the left end of the separation membrane complex 1 in the drawing. A substance having high permeability, i.e., a high-permeability substance, in the mixture of substances permeates the separation membrane 12 formed on the inner surface of each cell 111 and the support 11 and is derived from the outer surface of the support 11. In this way, the high-permeability substance (e.g., water) is separated from a low-permeability substance (e.g., ethanol), which is a substance having low permeability in the mixture of substances (step S22).

A substance derived from the outer surface of the support 11 (hereinafter, referred to as a “permeated substance”) is guided through the second exhaust port 223 to the second collector 28 as indicated by an arrow 253 and is then collected by the second collector 28. The permeated substance may include, in addition to the aforementioned high-permeability substance, a low-permeability substance that has permeated the separation membrane 12.

In the mixture of substances, those other than the substances that have permeated the separation membrane 12 and the support 11 (hereinafter, referred to as “non-permeated substances”) pass through each through hole 111 of the support 11 from the left side to the right side in the drawing and is collected by the first collector 27 through the first exhaust port 222 as indicated by an arrow 252. The non-permeated substances may include, in addition to the aforementioned low-permeability substance, a high-permeability substance that has not permeated the separation membrane 12. The non-permeated substance collected by the first collector 27 may, for example, be circulated to the supplier 26 and supplied again into the housing 22.

Next, the separation membrane complexes 1 according to Examples 1 to 6 and Comparative Examples 1 to 6 will be described with reference to Tables 1 and 2. Table 1 shows information on the starting material of the base material 31 of the separation membrane complex 1. Table 2 shows the relation of the physical properties of particles in the base material 31 of each separation membrane complex 1 (i.e., the physical properties of sintered particles), resistance to permeability, and strength.

TABLE 1

| | Coarse | | | |
|---|---|---|---|---|
| | Starting- | Fine Starting- | | Inorganic |
| | Material | Material | Content of Coarse | Binding |
| | Particles | Particles | Starting-Material | Material |
| | D₅₀ | D₅₀ | Particles | (Parts |
| | (μm) | (μm) | (mass %) | by Mass) |
| Example 1 | 90 | 40 | 30 | 10 |
| Example 2 | 60 | 20 | 5 | 20 |
| Example 3 | 90 | 40 | 20 | 18 |
| Example 4 | 60 | 20 | 5 | 15 |
| Example 5 | 90 | 40 | 20 | 3 |
| Example 6 | 60 | 20 | 5 | 25 |
| Comparative | 120 | 40 | 40 | 15 |
| Example 1 | | | | |
| Comparative | — | 20 | 0 | 15 |
| Example 2 | | | | |
| Comparative | 90 | 40 | 20 | 10 |
| Example 3 | | | | |
| Comparative | 90 | 40 | 20 | 15 |
| Example 4 | | | | |
| Comparative | 60 | 20 | 7 | 15 |
| Example 5 | | | | |
| Comparative | 60 | 20 | 3 | 10 |
| Example 6 | | | | |

TABLE 2

| | Physical Properties of Particles | | | | |
|---|---|---|---|---|---|
| | | Average | | | |
| | | Aspect | Surrounded | | |
| | Coarse | Ratio of | Fine | Evaluation | |
| | Particle | Coarse | Particle | Resistance to | |
| | Ratio | Particles | Ratio (%) | Permeability | Strength |
| Example 1 | 0.293 | 1.9 | 10 | ⊚ | ⊚ |
| Example 2 | 0.052 | 1.9 | 40 | ⊚ | ⊚ |
| Example 3 | 0.295 | 1.5 | 31 | ⊚ | ⊚ |
| Example 4 | 0.055 | 1.5 | 20 | ⊚ | ⊚ |
| Example 5 | 0.295 | 1.9 | 5 | ⊚ | ◯ |
| Example 6 | 0.055 | 1.5 | 55 | ◯ | ⊚ |
| Comparative | 0.343 | 1.9 | 21 | ⊚ | X |
| Example 1 | | | | | |
| Comparative | 0.025 | 1.9 | 20 | X | ⊚ |
| Example 2 | | | | | |
| Comparative | 0.297 | 1.2 | 15 | X | ⊚ |
| Example 3 | | | | | |
| Comparative | 0.296 | 2.5 | 23 | ⊚ | X |
| Example 4 | | | | | |
| Comparative | 0.063 | 2.5 | 20 | ⊚ | X |
| Example 5 | | | | | |
| Comparative | 0.053 | 1.2 | 15 | X | ⊚ |
| Example 6 | | | | | |

In Example 1, the separation membrane complex 1 was prepared by a production method similar to steps S11 to S15 described above. In the preparation of the green body serving as the starting material for the base material 31 in step S11, 10 parts by mass of glass serving as the inorganic binding material was added to 100 parts by mass of alumina particles serving as the aggregate particles. The content of the coarse starting-material particles in the alumina particles (i.e., the coarse starting-material particles and the fine starting-material particles) was 30 mass %. D₅₀ of the fine starting-material particles was 40 μm, whereas D₅₀ of the coarse starting-material particles was 90 μm. The firing temperature and the firing time for the molded body that became the base material 31 were set to 1250° C. and two hours, respectively. The seed crystals synthesized in step S12 were DDR-type zeolite crystals. The separation membrane 12 formed in each cell 111 in step S14 was a DDR-type zeolite membrane.

In the separation membrane complex 1 prepared in Example 1, the physical properties of the particles of the base material 31, i.e., the coarse particle ratio, was 0.293, the average aspect ratio of the coarse particles 311 was 1.9, and the surrounded fine particle ratio was 10%.

In Example 1, water permeability of the separation membrane complex 1 was measured as described below to evaluate the resistance to permeability. Firstly, the separation membrane complex 1 was attached to the inside of the housing 22 of the aforementioned separation apparatus 2, and a mixed solution of water and ethanol was supplied from the supplier 26 into the housing 22. In the mixed solution, the weight ratio of water and ethanol was 50:50. The temperature of the mixed solution supplied into the housing 22 was set to 60° C. Then, on the assumption that the pressure on the downstream side of the separation membrane 12, i.e., the permeate pressure, was set to 50 torr (about 6.666 kPa), the separation of the mixed solution was performed by a pervaporation method (so-called PV method) so as to measure the amount of permeated substances that had permeated the separation membrane complex 1 (i.e., permeance). Moreover, the density of the permeated substances was measured by a density indicator so as to obtain the ratio of water and ethanol in the permeated substance (hereinafter, also referred to as the “water/ethanol ratio”). Thereafter, the aforementioned permeance and the aforementioned water/ethanol ratio were used as a basis to obtain the amount of water that had permeated the separation membrane complex 1 (i.e., water permeability).

In Table 1, when the water permeability was higher than or equal to 2.8 kg/m2h, a “double circle” indicating that the resistance to permeability was favorably low was given in the “Resistance to Permeability” column. When the water permeability was higher than or equal to 2.3 kg/m2h and lower than 2.8 kg/m2h, an “open circle” indicating that the resistance to permeability was relatively low was given in the “Resistance to Permeability” column. When the water permeability was lower than 2.3 kg/m2h, a “cross” indicating that the resistance to permeability was relatively high was given in the “Resistance to Permeability” column. In Example 1, the resistance to water permeability was marked with the double circle.

In Example 1, the water admitted into each cell 111 of the separation membrane complex 1 was pressurized to measure internal-pressure breaking strength (i.e., pressure strength) at which the separation membrane complex 1 broke and to thereby evaluate the strength of the separation membrane complex 1. In Table 1, when the pressure strength was higher than or equal to 20 MPa, a “double circle” indicating that the strength was favorably high was given in the “Strength” column. When the pressure strength was higher than or equal to 18 MPa and lower than 20 MPa, an “open circle” indicating that the strength was relatively high was given in the “Strength” column. When the pressure strength was lower than 18 MPa, a “cross” indicating that the strength was low was given in the “Strength” column. In Example 1, the strength was marked with the double circle.

Example 2 was similar to Example 1, except that 20 parts by mass of the inorganic binding material was added to 100 parts by mass of the alumina particles in step S11, that the content of the coarse starting-material particles in the alumina particles was 5 mass %, that D₅₀ of the fine starting-material particles was 20 μm, and that D₅₀ of the coarse starting-material particles was 60 μm. In the base material 31 of the separation membrane complex 1 prepared in Example 2, the coarse particle ratio was 0.052, the average aspect ratio of the coarse particles 311 was 1.9, and the surrounded fine particle ratio was 40%. In Example 2, the resistance to water permeability was marked with the double circle, and the strength was also marked with the double circle.

Example 3 was similar to Example 1, except that 18 parts by mass of the inorganic binding material was added to 100 parts by mass of the alumina particles in step S11 and that the content of the coarse starting-material particles in the alumina particles was 20 mass %. In the base material 31 of the separation membrane complex 1 prepared in Example 3, the coarse particle ratio was 0.295, the average aspect ratio of the coarse particles 311 was 1.5, and the surrounded fine particle ratio was 31%. In Example 3, the resistance to water permeability was marked with the double circle, and the strength was also marked with the double circle.

Example 4 was similar to Example 2, except that 15 parts by mass of the inorganic binding material was added to 100 parts by mass of the alumina particles in step S11. In the base material 31 of the separation membrane complex 1 prepared in Example 4, the coarse particle ratio was 0.055, the average aspect ratio of the coarse particles 311 was 1.5, and the surrounded fine particle ratio was 20%. In Example 4, the resistance to water permeability was marked with the double circle, and the strength was also marked with the double circle.

Example 5 was similar to Example 3, except that 3 parts by mass of the inorganic binding material was added to 100 parts by mass of the alumina particles in step S11. In the base material 31 of the separation membrane complex 1 prepared in Example 5, the coarse particle ratio was 0.295, the average aspect ratio of the coarse particles 311 was 1.9, and the surrounded fine particle ratio was 5%. In Example 5, the resistance to water permeability was marked with the double circle, and the strength was marked with the open circle.

Example 6 was similar to Example 2, except that 25 parts by mass of the inorganic binding material was added to 100 parts by mass of the alumina particles in step S11. In the base material 31 of the separation membrane complex 1 prepared in Example 6, the coarse particle ratio was 0.055, the average aspect ratio of the coarse particles 311 was 1.5, and the surrounded fine particle ratio was 55%. In Example 6, the resistance to water permeability was marked with the open circle, and the strength was marked with the double circle.

Comparative Example 1 was similar to Example 1, except that 15 parts by mass of the inorganic binding material was added to 100 parts by mass of the alumina particles in step S11, that the content of the coarse starting-material particles in the alumina particles was 40 mass %, and that D₅₀ of the coarse starting-material particles was 120 μm. In the base material 31 of the separation membrane complex 1 prepared in Comparative Example 1, the coarse particle ratio was 0.343, the average aspect ratio of the coarse particles 311 was 1.9, and the surrounded fine particle ratio was 21%. In Comparative Example 1, the resistance to water permeability was marked with the double circle, and the strength was marked with the cross.

Comparative Example 2 was similar to Example 4, except that the content of the coarse starting-material particles in the alumina particles was 0 mass % in step S11 (i.e., the alumina particles did not include coarse starting-material particles). In the base material 31 of the separation membrane complex 1 prepared in Comparative Example 2, the coarse particle ratio was 0.025, the average aspect ratio of the coarse particles 311 was 1.9, and the surrounded fine particle ratio was 20%. In Comparative Example 2, the resistance to water permeability was marked with the cross, and the strength was marked with the double circle.

Comparative Example 3 was similar to Example 1, except that the content of the coarse starting-material particles in the alumina particles was 20 mass % in step S11. In the base material 31 of the separation membrane complex 1 prepared in Comparative Example 3, the coarse particle ratio was 0.297, the average aspect ratio of the coarse particles 311 was 1.2, and the surrounded fine particle ratio was 15%. In Comparative Example 3, the resistance to water permeability was marked with the cross, and the strength was marked with the double circle.

Comparative Example 4 was similar to Comparative Example 3, except that 15 parts by mass of the inorganic binding material was added to 100 parts by mass of the alumina particles in step S11. In the base material 31 of the separation membrane complex 1 prepared in Comparative Example 4, the coarse particle ratio was 0.296, the average aspect ratio of the coarse particles 311 was 2.5, and the surrounded fine particle ratio was 23%. In Comparative Example 4, the resistance to water permeability was marked with the double circle, and the strength was marked with the cross.

Comparative Example 5 was similar to Example 4, except that the content of the coarse starting-material particles in the alumina particles was 7 mass % in step S11. In the base material 31 of the separation membrane complex 1 prepared in Comparative Example 5, the coarse particle ratio was 0.063, the average aspect ratio of the coarse particles 311 was 2.5, and the surrounded fine particle ratio was 20%. In Comparative Example 5, the resistance to water permeability was marked with the double circle, and the strength was marked with the cross.

Comparative Example 6 was similar to Comparative Example 5, except that 10 parts by mass of the inorganic binding material was added to 100 parts by mass of the alumina particles in step S11 and that the content of the coarse starting-material particles in the alumina particles was 3 mass %. In the base material 31 of the separation membrane complex 1 prepared in Comparative Example 6, the coarse particle ratio was 0.053, the average aspect ratio of the coarse particles 311 was 1.2, and the surrounded fine particle ratio was 15%. In Comparative Example 6, the resistance to water permeability was marked with the cross, and the strength was marked with the double circle.

Comparisons of Examples 1 to 6 and Comparative Examples 1 to 2 show that the coarse particle ratio is preferably higher than or equal to 0.05 and lower than or equal to 0.3 from the viewpoint of achieving both a reduction in resistance to permeability of the base material 31 and the securing of the strength of the base material 31. Comparisons of Examples 1 to 6 and Comparative Examples 3 to 6 also show that the average aspect ratio of the coarse particles 311 is preferably higher than or equal to 1.5 and lower than or equal to 2 from the viewpoint of achieving both a reduction in resistance to permeability of the base material 31 and the securing of strength of the base material 31.

Comparisons of Examples 1 to 4 and Examples 5 and 6 show that the surrounded fine particle ratio is preferably higher than 5% from the viewpoint of further improving the strength of the base material 31. The surrounded fine particle ratio is also preferably lower than 55% from the viewpoint of further reducing the resistance to water permeability of the base material 31.

As described above, the porous ceramic base material (i.e., the base material 31) utilized for supporting the separation membrane 12 includes the plurality of coarse particles 311 each being a ceramic particle having a particle diameter of greater than or equal to 30 μm and the plurality of fine particles 312 each being a ceramic particle having a particle diameter of greater than or equal to 1 μm and less than 30 μm. The ratio of the number of coarse particles 311 to the number of fine particles 312 (i.e., the coarse particle ratio) is higher than or equal to 0.05 and lower than or equal to 0.3. The average aspect ratio of the coarse particles 311 is higher than or equal to 1.5 and lower than or equal to 2. This, as described above, allows the base material 31 to achieve both a reduction in resistance to permeability and the securing of strength.

As described above, it is preferable that the base material 31 may further include the inorganic binding material 313 that binds the coarse particles 311 and/or the fine particles 312. The number of fine particles 312 whose entire circumferences are surrounded by the inorganic binding material 313 among all of the fine particles 312 may preferably be greater than 5% and less than 55% of the total number of fine particles 312. This further improves the strength of the base material 31 and further reduces the resistance to permeability.

As described above, it is preferable that the base material 31 may have a porosity of higher than or equal to 20% and lower than or equal to 50%. This more favorably allows the base material 311 to achieve both a reduction in resistance to permeability and the securing of strength.

As described above, it is preferable that the coarse particles 311 and the fine particles 312 may be particles of alumina, mullite, zirconia, or titania. This increases the bonding strength of the base material 31 and the separation membrane 12 when the separation membrane 12 is provided directly on the base material 31. Accordingly, it is possible to stably support the separation membrane 12.

As described above, it is preferable that the base material 31 has a column-like shape extending in the longitudinal direction and includes the cells 11 that penetrate the base material 31 in the longitudinal direction. In this way, adopting the aforementioned structure also in the monolith or honeycomb separation membrane complex 1 allows the base material 31 to achieve both a reduction in resistance to permeability and the securing of strength.

It is preferable that the porous ceramic support (i.e., the support 11) utilized for supporting the separation membrane 12 may include the aforementioned base material 31 and the porous ceramic additional layer (i.e., the additional layer 34) provided on the surface of the base material 31 and having a mean pore diameter smaller than the mean pore diameter of the base material 31. This increases the bonding strength of the support 11 and the separation membrane 12 and allows the separation membrane 12 to be supported with stability.

The aforementioned separation membrane complex 1 includes either the aforementioned base material 31 or the aforementioned support 11 and the separation membrane 12 provided on the surface of the base material 31 or on the additional layer 34 of the support 11. This allows the separation membrane complex 1 to achieve both a reduction in resistance to permeability and the securing of strength.

As described above, it is preferable that the separation membrane 12 may be a zeolite membrane. If the separation membrane 12 is formed of zeolite crystals having a uniform pore diameter, it is possible to favorably achieve selective permeation of a high-permeability substance. As a result, it is possible to efficiently separate a high-permeability substance from a mixture of substances.

More preferably, the zeolite constituting the zeolite membrane may be composed of an 8- or less-membered ring at the maximum. This allows more favorably achieving selective permeation of a high-permeability substance having a relatively small molecular size. As a result, it is possible to more efficiently separate a high-permeability substance from a mixture of substances.

The base material 31, the support 11, and the separation membrane complex 1 described above may be modified in various ways.

For example, the porosity of the base material 31 may be lower than 20%, or may be higher than 50%. The surrounded fine particle ratio in the base material 31 may be lower than or equal to 5%, or may be higher than or equal to 55%.

In the separation membrane complex 1, the zeolite constituting the separation membrane 12, which is a zeolite membrane, may be composed of a more than 8-membered ring at the maximum. The separation membrane 12 is not limited to a zeolite membrane, and may be an inorganic membrane such as a silica membrane or a carbon membrane, or an organic membrane such as a polyimide membrane or a silicone membrane, or a metal organic framework (MOF) membrane. The separation membrane complex 1 may further include, in addition to the separation membrane 12, a functional membrane or a protection membrane that is laminated on the separation membrane 12. Such a functional or protection membrane may be a zeolite membrane, may be an inorganic membrane other than a zeolite membrane, or may be an organic membrane or an MOF membrane.

The separation membrane complex 1 does not necessarily need to be produced by the aforementioned production method (steps S11 to S15), and may be produced by any of various other production methods.

The separation membrane complex 1 may be utilized for the separation of a mixture of substances or for any other purpose in various apparatuses that are different in structure from the aforementioned separation apparatus 2.

The configurations of the above-described preferred embodiment and variations may be appropriately combined as long as there are no mutual inconsistencies.

While the invention has been shown and described in detail, the foregoing description is in all aspects illustrative and not restrictive. It is therefore understood that numerous modifications and variations can be devised without departing from the scope of the invention.

### INDUSTRIAL APPLICABILITY

The ceramic base material and the ceramic support according to the present invention can be utilized for supporting a zeolite membrane that is usable as a separation membrane. The separation membrane complex according to the present invention can be utilized as, for example, a separation membrane for various substances or an adsorption membrane for various substances.

### REFERENCE SIGNS LIST

1 separation membrane complex
11 support
12 separation membrane
31 base material
34 additional layer
111 cell
311 coarse particle
312 fine particle
313 inorganic binding material
S11 to S15, S21 to S22 step

1. A porous ceramic base material utilized for supporting a separation membrane, the ceramic base material comprising:
a plurality of coarse particles each being a ceramic particle having a particle diameter of greater than or equal to 30 μm; and
a plurality of fine particles each being a ceramic particle having a particle diameter of greater than or equal to 1 μm and less than 30 μm,
a ratio of a total number of said plurality of coarse particles to a total number of said plurality of fine particles is higher than or equal to 0.05 and lower than or equal to 0.3, and
said plurality of coarse particles have an average aspect ratio of higher than or equal to 1.5 and lower than or equal to 2.

2. The ceramic base material according to claim 1, further comprising:
an inorganic binding material that binds said plurality of coarse particles and/or said plurality of fine particles,
wherein a number of fine particles whose entire circumferences are surrounded by said inorganic binding material among said plurality of fine particles is greater than 5% and less than 55% of the total number of said plurality of fine particles.

3. The ceramic base material according to claim 1,
the ceramic base material having a porosity of higher than or equal to 20% and lower than or equal to 50%.

4. The ceramic base material according to claim 1, wherein
said plurality of coarse particles and said plurality of fine particles are particles of alumina, mullite, zirconia, or titania.

5. The ceramic base material according to claim 1,
the ceramic base material having a column-like shape extending in a longitudinal direction,
the ceramic base material including a plurality of cells that penetrate the ceramic base material in the longitudinal direction.

6. A porous ceramic support utilized for supporting a separation membrane, the ceramic support comprising:
the ceramic base material according to claim 1; and
a porous ceramic additional layer provided on a surface of said ceramic base material and having a mean pore diameter smaller than a mean pore diameter of said ceramic base material.

7. A separation membrane complex comprising:
the ceramic base material according to claim 1; and
a separation membrane provided on a surface of said ceramic base material or on said ceramic additional layer of said ceramic support.

8. The separation membrane complex according to claim 7, wherein
said separation membrane is a zeolite membrane.

9. The separation membrane complex according to claim 8, wherein
a zeolite constituting said zeolite membrane is composed of an 8- or less-membered ring at maximum.

10. A separation membrane complex comprising:
the ceramic support according to claim 6; and
a separation membrane provided on a surface of said ceramic base material or on said ceramic additional layer of said ceramic support.

11. The separation membrane complex according to claim 10, wherein
said separation membrane is a zeolite membrane.

12. The separation membrane complex according to claim 11, wherein
a zeolite constituting said zeolite membrane is composed of an 8- or less-membered ring at maximum.
